(19) United States
(12) Patent Application Publication
(10) Pub. No.: US 2026/0276146 A1
(43) Pub. Date: Sep. 17, 2026

(54) AN OIL RECOVERY SYSTEM

(71) Applicant: CORSAER HOLDING B.V., Nijmegen (NL)

(72) Inventor: Theodorus Petrus Maria Arntz, Nijmegen (NL)

(73) Assignee: CORSAER HOLDING B.V., Nijmegen (NL)

(21) Appl. No.: 19/475,562

(22) PCT Filed: Apr. 8, 2024
(86) PCT No.: PCT/NL2024/050179

§ 371 Date: Oct. 15, 2025

(30) Foreign Application Priority Data
Apr. 18, 2023 (NL) 2034602
Apr. 18, 2023 (NL) 2034603

(51) Int. Cl. F16N 39/00; F16C 33/66; F16N 7/40; F16N 39/02; F16N 39/04

(52) U.S. Cl. CPC F16N 39/005; F16C 33/667; F16N 7/40; F16N 39/02; F16N 39/04; F16N 2210/14; F16N 2270/10

(57) ABSTRACT

This disclosure relates to an oil recovery system for recovering oil. The oil recovery system comprises a container defining a holding space for holding oil. The holding space comprises an upper region and comprises a lower region for receiving solid contaminants that have sunk through the oil in the holding space. The oil recovery system also comprises a heating system that is configured to heat oil in the upper region to a greater extent than oil in the lower region. The heating system is configured to cause oil in the upper region to evaporate. The oil recovery system further comprises a condenser system that is configured to condense the evaporated oil and guide the condensed oil out of the container.

### FIELD OF THE INVENTION

This disclosure relates to technology for enabling local storage of excess energy produced by solar panels installed on for example residential houses. This disclosure relates to a lubrication oil circulation system, in particular to an oil circulation system comprising an oil recovery system that is configured to boil contaminated oil. This disclosure also relates to a pump system that is configured to dispense an amount of oil, to an oil recovery system and to computer-implemented methods, computer programs and computer-readable storage media for the oil recovery system.

### BACKGROUND

More and more solar panels are installed on buildings nowadays, in particular on residential houses. If at some time solar panels on a house generate more energy than is consumed at that time by the (devices in the) house, the excess energy is typically fed back to the main grid. This poses a challenge for power grid operators. The supply and demand in a power grid should be balanced carefully in order to prevent black-outs. It will be readily understood that the total energy supply from a significant number of solar panels on houses and other buildings cannot be controlled by a power grid operator and may be difficult to predict. Therefore, in order to mitigate the risk of power black-outs caused by for example a spike in energy supply from the solar panels in a region, a network operator should take appropriate technical, expensive measures.

Thus, from a power grid point of view, it would be preferred if the above mentioned excess energy generated by solar panels would be stored locally, for example at the house itself. This would obviate the need to feed the excess energy back into the main grid.

From the point of view of the owners of solar panels, it may also be preferred to locally store the excess energy. The monetary compensation that someone receives per amount of energy supplied back to the main grid is typically lower than the costs per amount of energy that have to be paid for energy drawn from the power grid. This is especially true if the excess energy is fed to the power grid at a time when the total energy supply to the grid is high and the total demand is low.

In light of the above, there is a need in the art for technology that enables a system for locally storing excess energy that is generated by solar panels, in particular solar panels that are installed on residential houses.

US 2006/0054404 A1 discloses an oil circulation system. U.S. Pat. No. 6,145,625 discloses a lubricator for delivering grease lubricant. This publication is not considered relevant to the technology described herein, because it does not describe oil lubricants. JPH09262403A discloses a device for recovering oil.

### SUMMARY

Storing energy in a flywheel has several advantages over storing energy in a battery. Batteries charge and discharge slower than flywheels, whereas the charge and discharge rate of flywheels is almost limitless. A flywheel may be able to power a washing machine, whereas a battery may not, due to its slow discharge rate. Another advantage of flywheels is that they have an almost endless lifetime, whereas the capacity of batteries significantly reduces after 1500-3000 charge-discharge cycles. It is very important that any system for locally storing excess energy generated by solar panels requires very little maintenance. The residents of a house are typically not technically qualified to perform maintenance on such system.

For a flywheel to have a high round trip efficiency, which may be understood as the ratio of energy retrieved from the flywheel to the energy put in, the friction experienced by its bearing(s) should be as low as possible. Magnetic bearings have no friction. However, magnetic bearings are not considered a viable option for use in a system for locally storing energy. They are namely quite expensive and, importantly, their controls consume a significant amount of energy relative to the amount of energy that is typically stored for a residential house.

Roller bearings are more suitable, especially hybrid bearings, which typically comprise ceramic rolling elements. Ceramic rolling elements are lighter and also less prone to deformation than steel rolling elements. Deformation of the rolling elements is undesired as it increases the friction that the flywheel experiences and/or shortens the lifetime of the flywheel.

Hybrid bearings are preferably lubricated with oil instead of grease. Hybrid bearings can namely achieve higher revolutions per minute (rpm) if lubricated with oil. This allows the flywheel to store more energy and/or to keep the flywheel relatively small. For a residential house, the flywheel preferably weighs less than 100 kg.

Of course, any oil that is used for lubricating the bearing of the flywheel should be very clean. Contaminants in the lubrication oil may significantly increase friction. At the same time, however, given that the system for locally storing excess energy should be very low maintenance, changing the lubrication oil should be avoided as much as possible. These two requirements may be met by a lubrication oil circulation system that somehow cleans the oil during the circulation.

Hence, a lubrication oil circulation system is disclosed. Optionally, the lubrication oil circulation system is hermetically sealed. The lubrication oil circulation system comprises a lubrication oil dispenser system that is configured to provide lubrication oil to a bearing. The lubrication oil circulation system also comprises a container defining a holding space for holding contaminated lubrication oil that has come out of the bearing. Further, the oil circulation system comprises an oil recovery system that is configured to boil the contaminated lubrication oil in order to evaporate clean lubrication oil and condense the clean, evaporated lubrication oil. In addition, the lubrication oil circulation system comprises a transport system that is configured to transport the clean, condensed lubrication oil to the lubrication oil dispenser system so that the lubrication oil dispenser system can provide the clean lubrication oil to the bearing.

This oil circulation system is advantageous for use in a system for locally storing excess energy. The system namely enables to lubricate, with oil, high rpm vacuum flywheels while having low maintenance requirements. As referred to herein, a high rpm flywheel may be understood as a flywheel that is configured to rotate a very high rotary speed, e.g. higher than 6000 rpm. The oil circulation system, if hermetically sealed, can be connected to a vacuum flywheel without releasing the vacuum. As known, flywheels preferably operate in vacuum in order to significantly reduce the friction experienced by the flywheel and eliminate noise of the rotating flywheel in air. Advantageously, the oil recovery system outputs clean oil by boiling off clean oil from the contaminated oil. Hence, the use of filters, which have to be periodically replaced, is obviated. The contaminants in the contaminated oil may simply remain in the holding space. This is not necessarily problematic, especially not if the holding space is large enough so that it can accommodate large amounts of contaminants. Preferably, the holding space is large enough to accommodate all contaminants that come out of the bearing during the entire lifetime of the system, which may be longer than 25 years. Of course, the accumulated contaminants should not distort the functioning of the oil recovery system too much.

The lubrication oil referred to herein may be a synthetic oil, such as polyalphaolefin (PAO) and/or polyalphaolefin-2 (POA2). A synthetic oil does not degenerate in contrast to for example mineral oils. Additionally or alternatively, the lubrication oil is a pure substance and not a blend. Additionally or alternatively, the lubrication oil has a boiling point as opposed to a boiling range. This renders the boiling process more efficient.

In an embodiment, the lubrication oil circulation system comprises an oil level meter that is configured to measure an amount of contaminated lubrication oil in the holding space.

This embodiment is advantageous in that it allows the oil recovery system to operate in a batch-wise manner. If the oil level meter for example indicates that a certain level is reached, then the oil recovery system may initiate the boiling of the contaminated oil. Once some amount of clean oil has been obtained by the oil recovery system, the oil recovery system may switch off again until the contaminated oil in the holding space reaches the certain level. Typically, the amount of oil that comes out of the bearing per unit of time is far smaller than the amount of oil that evaporates per the same unit of time when the oil recovery system is boiling the contaminated oil. Hence, the oil recovery can be switched off most of the time, which reduces its energy consumption.

In an embodiment, the lubrication oil circulation system comprises a control system that is configured to perform steps of (i) receiving from the oil level measurement system a signal indicative of an amount of oil in the holding space, and (ii) based on the indicated amount of oil in the holding space, causing the oil recovery system to initiate boiling of the contaminated lubrication oil.

In an embodiment, the lubrication oil circulation system comprises a control system that is configured to perform steps of (iii) receiving from the oil level measurement system a second signal indicative of a second amount of oil in the holding space, and (iv) based on the indicated second amount of oil in the holding space, causing the oil recovery system to stop boiling the contaminated oil in the holding space.

In an embodiment of the lubrication oil circulation system, the lubrication oil circulation system is configured to accommodate a pressure that is lower than 5 mbar absolute. Preferably the lubrication oil circulation system is under full vacuum or near full vacuum.

This embodiment is advantageous in that a low pressure, such as a full vacuum or near full vacuum, is not only beneficial for reducing the friction with the air as experienced by the flywheel, but also in that the contaminated lubrication oil in the holding space will start boiling at lower temperatures.

The above mentioned pressure may be an average pressure, for example an average pressure over time and/or over position within the oil circulation system.

One aspect of this disclosure relates to a hermetically sealed system comprising any of the lubrication oil circulation systems described herein and the bearing.

Thus, in this aspect, the lubrication oil circulation system is airtight connected to the bearing.

In an embodiment, the bearing is a rolling bearing. Such rolling bearing consumes little energy during use.

In an embodiment, the rolling bearing comprises rolling elements comprising ceramic. Preferably, the rolling elements essentially consist of ceramic. Such rolling elements are less prone to deformation and therefore extend the lifetime of the bearing. A rolling element referred to herein may be a ball.

In an embodiment, the system comprises a flywheel. The flywheel comprises the bearing and is configured to store kinetic energy. In this embodiment, the system also comprises an electromotor that is configured to power the flywheel.

This embodiment can be installed at for example a residential house and allows to store excess electrical energy. Any excess electrical energy may namely be used to power the electromotor, which, in turn, powers the flywheel. The bearing of the flywheel is then lubricated by lubrication oil that circulates in the oil circulation system.

The flywheel is preferably configured to store at least 5 kWh.

In an embodiment, the system comprises a generator that is configured to convert the kinetic energy stored by the flywheel into electrical energy. Typically, the electromotor and the generator are combined in a so-called electromotor-generator.

In an embodiment, the system comprises a photovoltaic cell that is configured to power the electromotor.

In this embodiment, excess electrical energy as generated by the PV cell can thus be stored as kinetic energy in the flywheel.

In an embodiment of the lubrication oil circulation system, the lubrication oil dispenser system comprises any of the pump systems disclosed herein (see below).

The oil recovery system of the lubrication oil circulation system may be any of the oil recovery systems disclosed herein.

One distinct aspect of this disclosure relates to a pump system that is configured to dispense an amount of oil. The pump system comprises a static structure. The pump system also comprises a check-valve that is configured to allow oil to pass through upon a pressure differential between two sides of the check-valve exceeding a threshold value. The pump system further comprises a first piston that is movable relative to the static structure between a first position and a second position, and a second piston that is movable relative to the static structure and movable relative to the first piston. The first piston, second piston, static structure and check-valve are configured to, when the first piston is in the second position, close off an area containing to-be-dispensed oil. Further, the second piston is configured to move relative to the first piston into the closed-off area for increasing a pressure in the closed-off area for causing the check-valve to allow oil to pass from the area through the check-valve for being dispensed out of the pump system. The pump system further comprises a first spring that abuts at one end to the first piston and abuts at another end to the second piston. The pump system also comprises a second spring that abuts at one end to the first piston and at another end to the static structure.

This pump system is advantageous in that it can function in vacuum. The pressure differential that is used to dispense oil out of the pump is namely caused by the second piston moving into the closed-off (three dimensional) area. The pump system thus creates a pressure differential only locally, i.e. only between the two sides of the check-valve. In other words, only a small amount of oil needs to be put under pressure with each pump stroke. This advantageously limits the energy that is required for each pump stroke. Further, the configuration of the pump requires leak-proof seals in only a small area, namely only at and/or near the closed-off area. It is for example not required that a seal is present between the second piston and a pump housing in which the second piston moves up and down. As a side note, if such a seal between second piston and a pump housing would be present, then lubricating the second piston would be far more challenging.

A further advantage of the pump system is that it requires only a single point of application for a driving force. In principle, the driving force for the pump system may be applied only to the second piston. When the second piston is driven, for example from an initial position towards the area that is going to be closed off, the first spring may cause the first piston to move from the first position to the second position in order to close off the area containing to-be-dispensed oil. Once the area has been closed off, the second piston, still being driven by the driving force applied to it, can continue its movement in order to move into the closed-off area which causes the dispensing of oil. Once the driving force is no longer applied to the second piston, the second spring acts to return the first piston to the first position and the first spring acts to return the second piston to its initial position again. Thus, the pump system can be driven by a solenoid that drives only the second piston. The fact that a relatively simple solenoid can be used for driving the entire pump system is advantageous, especially in the context of a low maintenance system for locally storing excess energy, because solenoids can reliably operate for years without any maintenance.

The pump system can be designed to accurately dispense a certain amount of oil. The amount of oil that is dispensed with each pump stroke is dependent on how far the second piston moves into the closed-off area and its diameter. Calibration measurements may be performed to ensure that with each stroke the proper amount of oil is dispensed.

Preferably, the first piston, when in the second position, contacts the static structure. When the first piston is in the second position, the static structure may block the first piston from moving further. In such case, the first piston would remain in the second position while the second piston moves into the closed-off area. The static structure and the first piston may have surfaces that are complementary to each other so that the surface of the first piston sits tight against the surface of the static structure when the first piston is in the second position. Preferably, when the first piston is in the second position, a surface of the first piston sits flush against a surface of the static structure in order to tightly close off the area.

In an embodiment, the pump system comprises a housing. The static structure may be part of the housing and/or may be static relative to the housing. The static structure may comprise a recess that partially defines the closed-off area.

The check-valve may be embedded in the static structure. The check-valve may be a ball check-valve.

It should be appreciated that in addition to the first piston, second piston, static structure and check-valve other elements may also aid to close off the area containing the to-be-dispensed oil.

The first piston and second piston may each be movable relative to the static structure back and forth along a first direction. The first and second piston may each be movable only along this first direction (back and forth).

In an embodiment of the pump system, the first piston and second piston are configured to, upon the first piston moving back to the first position, open up the area so that new to-be-dispensed oil can flow from outside the area into the area.

In an embodiment of the pump system, at least part of the second piston is movable through the first piston. In such embodiment, the pump system may comprise a seal between the first piston and the second piston.

As said, the first piston and second piston may be configured to move along a first direction. As viewed along this first direction, the first piston may surround the second piston. In such case, the first piston may be referred to as the external piston and the second piston may be referred to as the internal piston.

In an embodiment of the pump system, the seal may comprise vulcanized rubber. Such a seal is advantageous in that it is very durable. More durable than typical O-rings, for example, which may have to be replaced periodically.

In an embodiment of the pump system, the second piston is configured to move relative to the first piston into the closed-off area for increasing the pressure hereby moving from an initial position relative to the first piston to an end position relative to the first piston and hereby moving to a fourth position relative to the static structure. In this embodiment, the first spring may be configured to cause the second piston to move back from the end position to the initial position.

The first spring may thus act to keep the first piston and second piston at predefined positions relative to each other. A (single) driving force can, of course, change the relative positions of the first piston and second piston.

In an embodiment of the pump system, the second piston is movable relative to the static structure between a third position and a or the fourth position. In this embodiment, the first spring may be configured to, when the second piston is moving from the third position to the fourth position, cause the first piston to move from the first position to the second position.

In an embodiment of the pump system, the first spring is configured to be in a compressed state when the second piston is in the end position relative to the first piston.

Preferably, the first spring is configured to be already in a compressed state when the second piston is in the initial position relative to the first piston.

In an embodiment of the pump system, the second spring is configured to cause the first piston to move back from the second position to the first position.

In an embodiment of the pump system, the second spring is configured to be in a compressed state when the first piston is in the second position.

Preferably, the second spring is configured to be already in a compressed state when the first piston is in the first position.

In an embodiment of the pump system, the first spring and the second spring have substantially equal spring constants.

In an embodiment, the pump system comprises a solenoid that is configured to drive the second piston from a or the third position to a or the fourth position.

The driving force provided by the solenoid may have a single point of application, wherein the single point of application is on the second piston.

In an embodiment, the pump system comprises an oil-containing oil reservoir, wherein the first spring and/or the second spring are positioned in the oil reservoir and are immersed in the oil in the oil reservoir.

Preferably, all areas of the pump system where two moving elements slide against each other are immersed in oil. Preferably, the static structure and the first piston are immersed in the oil in the oil reservoir. Preferably, the solenoid is immersed in the oil in the oil reservoir.

This embodiment is advantageous in that the oil in the oil reservoir may serve to refill the area (once opened up) while at the same time serve to keep the moving parts of the pump system well lubricated. Preferably, the oil from the oil reservoir automatically flows into the area (once opened up), thus without requiring any additional pump mechanism.

In an embodiment, the pump system is configured to dispense, with each pump stroke, an amount of oil less than 30 cubic millimeter, preferably less than 20 cubic millimeter, more preferably less than 10 cubic millimeter. The pump system disclosed herein is very suitable for accurately dispensing small amounts of oil. Therefore, the pump can be suitably used for lubricating bearings that are to be lubricated with small amounts of oil.

One aspect of this disclosure relates to an oil recovery system for recovering oil. The oil recovery system comprises a container defining a holding space for holding oil. The holding space comprises an upper region and comprises a lower region for receiving solid contaminants that have sunk through the oil in the holding space. The oil recovery system also comprises a heating system that is configured to heat oil in the upper region to a greater extent than oil in the lower region. The heating system is configured to cause oil in the upper region to evaporate. The oil recovery system further comprises a condenser system that is configured to condense the evaporated oil and guide the condensed oil out of the container.

This oil recovery system enables to recover oil that is very clean and that can be subsequently used for lubricating a bearing of a high rpm flywheel, for example. Because the heating system is configured to heat oil in the upper region to a greater extent than oil in the lower region, it can achieve that only the oil in the upper region reaches the boiling temperature, whereas oil in the lower region does not. As a result, bubbles will originate in the upper region and to a lesser extent in the lower region. This is advantageous because bubbles that originate in the lower region will be moving at a relatively high speed once they reach the oil surface, whereas bubbles that originate in the upper region will be travelling at a lower speed once they reach the oil surface. Bubbles preferably reach the oil surface at a lower speed. This will namely reduce the intensity of splashing that occurs at the oil surface caused by the bubbles exiting the oil there. The lower intensity of splashing reduces the risk that contaminants are splashed out of the oil and out of the holding space where they can contaminate condensed, clean oil. Even further, because the oil in the lower region does not boil, it will not cause the contaminants that have ended up there to be swirled through the holding space. If this would occur, then there would be a higher risk that contaminants are present in the upper region from where they can be launched out of the holding space due to the splashing there. Hence, the oil recovery system enables to recover oil having a high degree of purity. The oil recovery system can thus be suitably used in the lubrication oil circulation system disclosed herein.

In principle, the contaminants will remain in the holding space, preferably in the lower region, for an indefinite period of time. The container may comprise, at the lower region of the holding space, a faucet. By temporarily opening the faucet, contaminants accumulated in the lower region can exit the container through it.

The condenser system may be hermetically sealed and can therefore be airtight connected to other hermetically sealed systems, such as to the pump system disclosed herein, and/or be used in any of the oil circulation systems described herein. This for example allows the system to operate in (near) full vacuum.

In an embodiment of the oil recovery system, the heating system is configured to cause oil in the upper region to boil without causing oil in the lower region to boil.

In addition to the above advantages, a further advantage is that the oil recovery system consumes relatively little energy.

In an embodiment of the oil recovery system, the heating system comprises a heater element that is configured to convert electrical energy into heat. In such embodiment, the heater element may sit in the holding space.

Preferably, the heater element is positioned such that it will be completely immersed in oil when oil in the holding space is boiling. The density of the oil will reduce if it is heated.

In an embodiment of the oil recovery system, the heating system comprises a heater element that is configured to convert electrical energy into heat. In such embodiment, the heater element is positioned nearer to the upper region than to the lower region of the holding space.

In an embodiment of the oil recovery system, the heater element is positioned in the upper region of the holding space.

In an embodiment of the oil recovery system, the heating system comprises a heater element that is configured to convert electrical energy into heat. In this embodiment, the condenser system may comprise a condensation surface that is configured to cause the evaporated oil to condense on it. Further, in this embodiment, the heater element is positioned closer to the condensation surface than to the lower region of the holding space, for example closer to the condensation surface than to a bottom surface of the container defining the holding space.

In an embodiment of the oil recovery system, the holding space is holding an amount of oil as a result of which an oil surface is present in the holding space. In such embodiment, the heater element is preferably positioned closer to the oil surface than to the lower region of the holding space. Additionally or alternatively, at least part of the heater element is positioned below the oil surface. Preferably, at least half of the heater element, in terms of volume, is positioned below the oil surface. More preferably, at least 75% of the heater element, in terms of volume, is positioned below the oil surface. Most preferably, the heater element is completely below the oil surface.

If the holding space is holding an amount of oil, then the region in the holding space that contains the oil surface may be understood as the upper region of the holding space, irrespective of the dimensions of the holding space.

In an embodiment, the oil recovery system comprises a mesh structure in the holding space that is configured to burst bubbles that are rising in the oil in the holding space.

The mesh advantageously prevents that large bubbles reach the oil surface which would cause significant splashing with the associated risk of expelling contaminants out of the holding space.

The mesh structure may be immersed in the oil.

If the oil recovery system comprises a mesh structure in the holding space that is configured to burst bubbles that are rising in the oil in the holding space, then the heating system is not necessarily configured to heat oil in the upper region to a greater extent than oil in the lower region, and is not necessarily configured to cause oil in specifically the upper region to evaporate. In such case, the heating system may be, more generally stated, be configured to cause oil in the holding space to evaporate. The mesh structure can reduce the degree of splashing at the oil surface irrespective of how the heating system is configured.

In an embodiment, the oil recovery system comprises a collar that is at least partially provided around the container. Preferably, however, the collar completely surrounds the container. The collar comprises a first recess and a second recess that is more distant from the container than the first recess. Herein, the condenser system is configured to guide the condensed oil into the second recess.

This embodiment is advantageous in that any contaminated oil that is expelled unintentionally from the holding space will end up in the first recess and not in the second recess. Herewith, it is prevented that contaminated oil reaches the second annular recess wherein the clean, condensed oil is collected.

Both the first recess and the second recess preferably completely surround the container. The first recess and second recess are preferably configured such that contaminated oil that is unintentionally expelled from the container, will meet the first recess before the second recess so that the contaminated oil will end in the first recess and does not reach the second recess, where only clean oil should arrive.

The first recess and/or the second recess may be annularly shaped. If both the first and second recess are annularly shaped, then the second recess has a larger radius than the first recess.

If the oil recovery system comprises a collar that is at least partially provided around the container, the collar comprising a first recess and a second recess that is more distant from the container than the first annular recess, then the heating system is not necessarily configured to heat oil in the upper region to a greater extent than oil in the lower region, and is not necessarily configured to cause oil in specifically the upper region to evaporate. In such case, the heating system may be, more generally stated, be configured to cause oil in the holding space to evaporate. The collar can prevent contaminated oil from mixing with clean oil irrespective of how the heating system is configured.

In an embodiment of the oil recovery system, comprises an oil level measurement system that is configured to measure an amount of oil in the holding space.

In an embodiment, the oil recovery system comprises a control system that is configured to perform steps of
receiving from the oil level measurement system a signal indicative of an amount of oil in the holding space, and
based on the indicated amount of oil in the holding space, causing the heating system to heat the oil in the holding space herewith causing at least some of the oil in the holding space to evaporate.

The heating system may comprise a controller that is configured to control an amount of heat that is produced by the heating system

The control system may be configured to control the heating system such that during a boiling session, only a relatively small part of the oil in the holding space evaporates.

In an embodiment, the oil recovery system comprises a control system that is configured to perform steps of
receiving from the oil level measurement system a second signal indicative of a second amount of oil in the holding space, and
based on the indicated second amount of oil in the holding space, causing the heating system to lower its heat production, preferably to switch off, so that the oil in the holding space no longer evaporates.

One aspect of this disclosure relates to a computer-implemented method for controlling any of the heating systems disclosed herein. The method comprises receiving from the oil level measurement system a signal indicative of an amount of oil in the holding space. The method also comprises, based on the indicated amount of oil in the holding space, causing the heating system to heat the oil in the holding space herewith causing at least some of the oil in the holding space to evaporate.

Optionally, this method comprises receiving from the oil level measurement system a second signal indicative of a second amount of oil in the holding space and causing, based on the indicated second amount of oil in the holding space, the heating system to lower its heat production, preferably to switch off, so that the oil in the holding space no longer evaporates.

One aspect of this disclosure relates to a computer-implemented method for controlling any of the heating systems disclosed herein. The method comprises receiving from the oil level measurement system a second signal indicative of a second amount of oil in the holding space. The method also comprises, based on the indicated second amount of oil in the holding space, causing the heating system to lower its heat production, preferably to switch off, so that the oil in the holding space no longer evaporates.

One aspect of this disclosure relates to a computer program comprising instructions which, when the program is executed by a data processing system, cause the data processing system to perform any of the computer-implemented methods disclosed herein.

One aspect of this disclosure relates to computer-readable storage medium having stored thereon any of the computer programs disclosed herein.

One distinct aspect of this disclosure relates to a further oil recovery system for recovering oil. This further oil recovery system comprises a container defining a holding space for holding oil and a heating system that is configured to heat the oil in the holding space for causing at least some of the oil to evaporate. The oil recovery system also comprises a condenser system that is configured to condense the evaporated oil and guide the condensed oil out of the container. The further oil recovery system also comprises an oil level measurement system that is configured to measure an amount of oil in the holding space. The further oil recovery system also comprises a control system that is configured to perform steps of:
receiving from the oil level measurement system a signal indicative of an amount of oil in the holding space, and
based on the indicated amount of oil in the holding space, causing the heating system to heat the oil in the holding space herewith causing at least some of the oil in the holding space to evaporate.

Thus, the heating system of this further oil recovery system is not necessarily configured to heat oil in an upper region of the holding space to a greater extent than oil in a lower region of the holding space. However, it should be appreciated that the further oil recovery system described herein may comprise any of the features described in relation to the oil recovery system.

In an embodiment of the further oil recovery system, the control system is configured to perform steps of:
determining that the indicated amount of oil exceeds a threshold value, and
based on this determination, performing the step of causing the heating system to heat the oil in the holding space.

In an embodiment of the further oil recovery system, the control system is configured to perform steps of:
receiving from the oil level measurement system a second signal indicative of a second amount of oil in the holding space, and
based on the indicated second amount of oil in the holding space, causing the heating system to lower its heat production, preferably to switch off, so that the oil in the holding space no longer evaporates.

In an embodiment of the further oil recovery system, the control system is configured to perform steps of:
determining that the indicated amount of oil is lower than a second threshold value, and
based on this determination, performing the step of causing the heating system to lower its heat production, preferably to switch off.

Herein, determining that some indicated amount of oil exceeds or is lower than some threshold value may comprise comparing that indicated amount of oil with that threshold value.

One aspect of this disclosure relates to a computer program comprising instructions which, when the program is executed by a computer, cause the computer to carry out any of the computer-implemented methods described herein.

One aspect of this disclosure relates to a computer-readable data carrier having stored thereon any of the computer programs described herein.

The computer-readable data carrier may be hard disk, for example, or a signal.

One aspect of this disclosure relates to a computer readable storage medium having computer readable program code embodied therewith, and a processor, preferably a microprocessor, coupled to the computer readable storage medium, wherein responsive to executing the computer readable program code, the processor is configured to perform any of the computer-implemented methods described herein.

One aspect of this disclosure relates to a computer program or suite of computer programs comprising at least one software code portion or a computer program product storing at least one software code portion, the software code portion, when run on a computer system, being configured for executing any of the computer-implemented methods described herein.

One aspect of this disclosure relates to a non-transitory computer-readable storage medium storing at least one software code portion, the software code portion, when executed or processed by a computer, is configured to perform any of the computer-implemented methods described herein.

One aspect of this disclosure relates to a data carrier signal carrying any of the computer programs described herein.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 illustrates a lubrication oil circulation system according to an embodiment,

FIGS. 2A and 2B illustrate respective bearings according to respective embodiments,

FIG. 3 illustrates a flange system according to an embodiment,

FIG. 4 is a flow chart illustrating a method according to an embodiment,

FIG. 5 illustrates a pump system according to an embodiment,

FIG. 6 illustrates functioning of the pump system of FIG. 5, according to an embodiment,

FIG. 7A illustrates a pump system according to an embodiment, wherein some parts are immersed in lubrication oil,

FIG. 7B illustrates a pump system comprising an oil level meter according to an embodiment,

FIG. 7C shows the oil flow in a pump system according to an embodiment,

FIG. 8 illustrates an oil recovery system according to an embodiment,

FIG. 9 illustrates an oil recovery system according to an embodiment comprising a collar having two recesses,

FIG. 10 is a top view of the oil recovery system shown in FIG. 9,

FIG. 11 illustrates an embodiment of the oil recovery system in which contaminated is oil is fed back to the holding space,

FIG. 12 illustrates an embodiment of the oil recovery system wherein the collar is conically shaped,

FIG. 13 illustrates an embodiment of the oil recovery system comprising an upper edge that is tilted outwardly,

FIG. 14 illustrates an embodiment of the oil recovery system comprising a heater element that is easily replaceable,

FIG. 15 illustrates how, according to an embodiment, the heating system can be controlled,

FIG. 16 illustrates a data processing system, e.g. a control system, according to an embodiment.

### DETAILED DESCRIPTION OF THE DRAWINGS

In the figures, identical reference numbers indicate identical or similar elements.

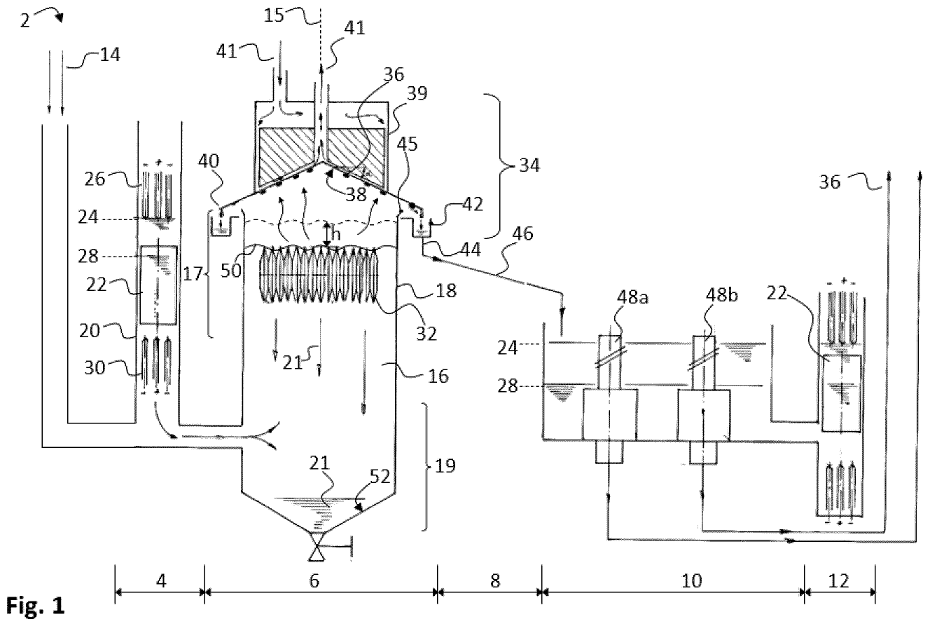

FIG. 1 schematically illustrates a lubrication oil circulation system 2 according to an embodiment. The system 2 comprises an oil level meter 4, an oil recovery system 6, a transport system 8, a lubrication oil dispenser system 10, and an oil level meter 12. Contaminated lubrication oil 14 that has for example come out of a bearing, is shown to enter into the holding space 16 of the container 18. The holding space 16 comprises an upper region 17, and comprises a lower region 19 for receiving solid contaminants 21 that have sunk through the oil in the holding space 16. The contaminated lubrication oil 14 can remain for some time period in the holding space 16. Preferably, the container is a cylinder, e.g. in the sense that its side walls are substantially circularly symmetric around axis 15.

The oil level meter 4 is configured to measure the amount of contaminated lubrication oil 14 that is present in the holding space 16. Since the oil level meter 4 and the container 18 are in fluid communication with each other, the oil level in the housing 20 of the oil level meter 4 will be as high as the oil level in the holding space 16. A float 22 will rise and fall with the oil level in the oil level meter 4. When a top surface of the float 22 has risen to level 24, it will contact top electrodes 26. The float 22 will then close an electrical circuit as a result of which a signal may be received by some control system (not shown). Such signal is thus indicative of a (relatively large) amount of oil in the holding space 16. As such, the oil level meter 4 is configured to measure an amount of oil in the holding space 16. A control system may be configured to initiate the boiling process if it receives a signal indicating that there is a relatively large amount of oil present in the container 18. When the top surface of the float 22 has moved down to level 28, due to the evaporation of part of the oil out of the holding space 16, the bottom surface of the float 22 will contact electrodes 30. Again, the float 22 will close an electrical circuit as a result a second signal may be received by a control system, the second signal being indicative of a relatively low oil level in the holding space 16. A control system may be configured to stop the boiling process based on receiving a signal indicative of the relatively low oil level.

In the depicted embodiment, the set of electrodes 26 and the set of electrodes 30 each comprises three pins, two of them being already electrically connected to each other. It will be readily understood that the oil itself is preferably electrically isolating so that the oil between the pins does not electrically connect the pins 26 to each other.

The oil recovery system 6 is configured to boil the contaminated lubrication oil in the holding space 16 in order to evaporate clean lubrication oil and condense the clean, evaporated lubrication oil. To this end, the depicted oil recovery system 2 comprises a heating system comprising a heater element 32 as well as a condenser system 34.

The depicted heating system is configured to heat oil in the upper region 17 to a greater extent than oil in the lower region 19. The heating system, at least its heater element 32 that converts electrical energy into heat, is depicted inside of the holding space 16. However, this is not strictly necessary. The heater element 32 is positioned nearer to the upper region 17 than to the lower region 19. In the depicted embodiment, the heater element is positioned in the upper region, and no heater element is present in the lower region. Additionally or alternatively, as shown, if the holding space is holding an amount of oil, the heater element 32 is positioned closer to the oil surface 50 than to the lower region 19. Additionally or alternatively, also as shown, heater element 32 is positioned closer to a condensation surface 38 than to the lower region 19 of the holding space, for example closer to the condensation surface 38 than to a bottom surface 52 of the container defining the holding space 16.

Preferably, right before the boiling process starts, when the oil is still at room temperature, the oil surface is at the same level as the top of the heater element 32, or a few millimeters, e.g. 5 mm, above the top of the heater element. When the oil heats up, the specific volume of the oil increases and the oil surface will rise, for example over a distance h as indicated in FIG. 1. Preferably, at all times, the oil surface is not lower than the top of the heater element 32 while the heater element is switched on. If this would be the case, the heater element 32 may then overheat and break down.

Due to the heat provided by the heating system, oil in the upper region 17 evaporates. It should be appreciated that the oil vapor in principle does not contain any contaminants 21. The contaminants may permanently remain in the holding space 16. The container 18 may comprise an upper edge 45 that is slightly tilted outwardly for preventing that contaminated oil reaches the drain channel 42, e.g. due to splashing at the oil surface. The condenser system 34 condenses the evaporated oil and guides the condensed oil 36 out of the container 18. In FIG. 1, the oil vapor is shown to condense on a surface 38 of the condenser system. Optionally, the surface 38 is actively cooled by a cooling system 39. Cooling liquid 41, such as water, can be forced to flow along a surface opposite the surface 38 herewith cooling the surface 38. The droplets 36 of condensed oil attach to this surface 38 and slide downwards towards a relatively sharp edge 40 where the droplets fall into a drain channel 42. The drain channel 42 preferably surrounds the container 18. The drain channel 42 as a whole is slightly sloped so that any oil that is present anywhere in the drain channel 42 flows to an outlet 44 of the channel.

The outlet 44 of the drain channel 42 is fluidly connected to one or more tubes 46 that form a transport system 8 via which the clean, condensed lubrication oil 36 can be transported, preferably passively, to the lubrication oil dispenser system 10 so that the lubrication oil dispenser system 10 can provide the clean lubrication oil 36 to for example one or more bearings.

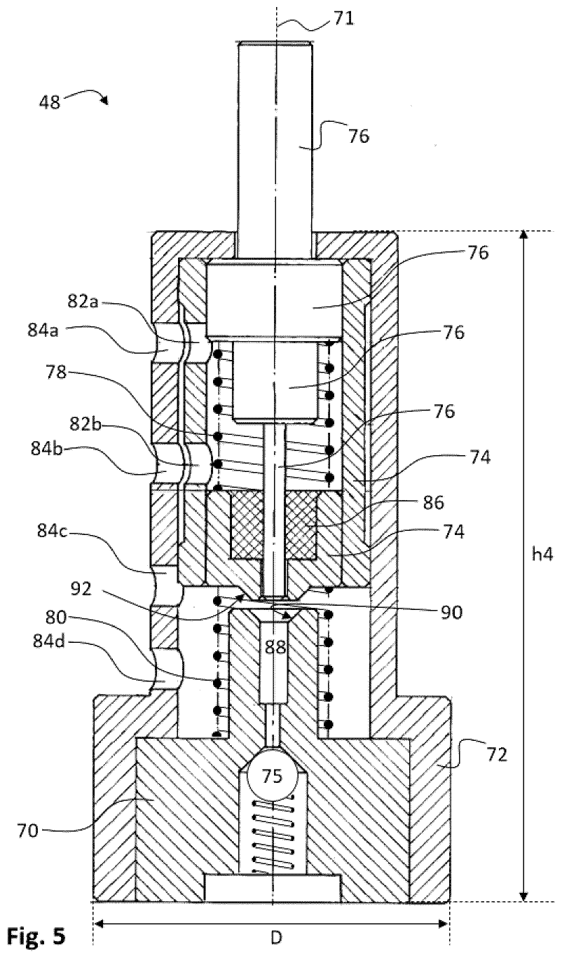

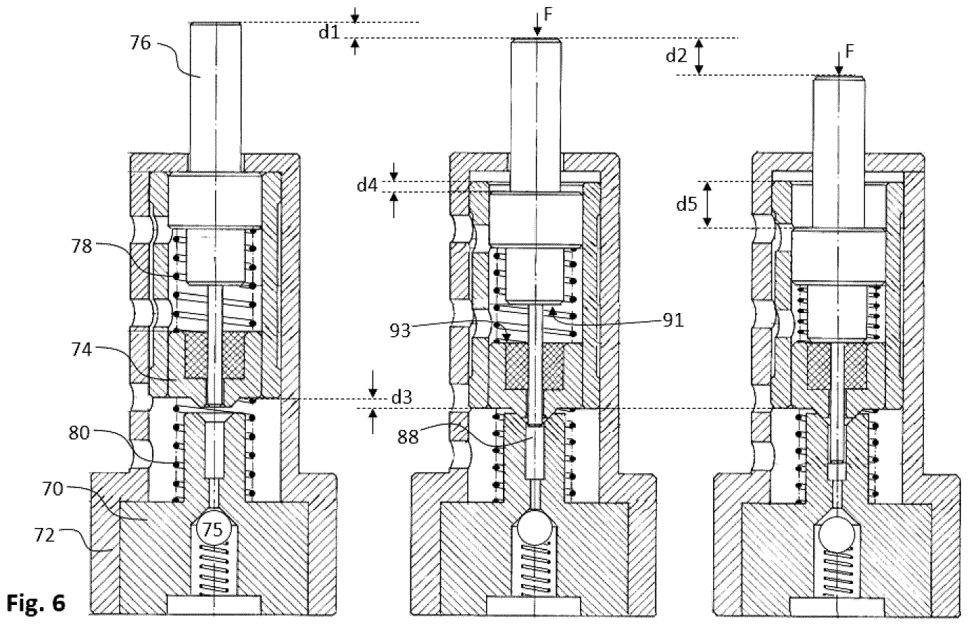

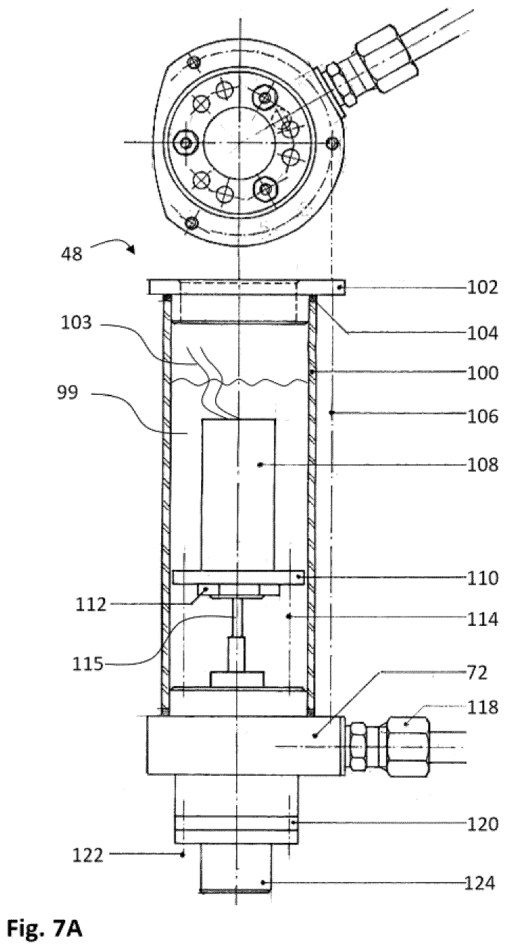

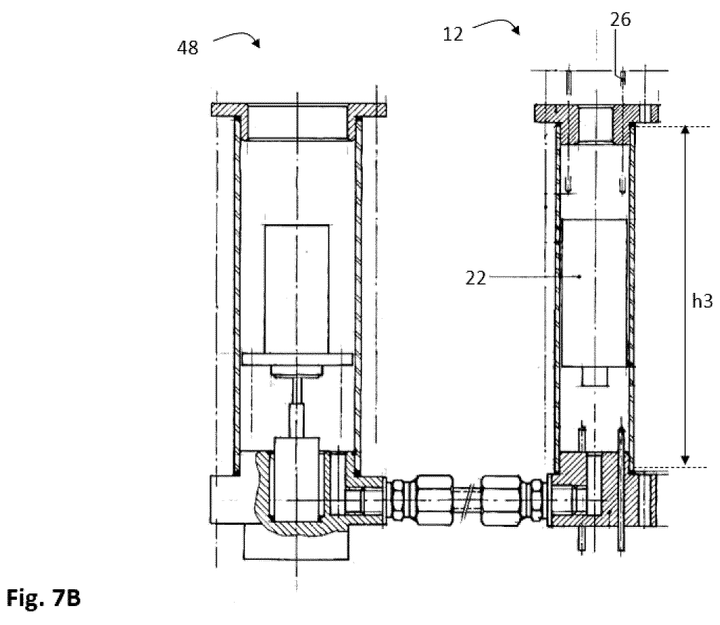

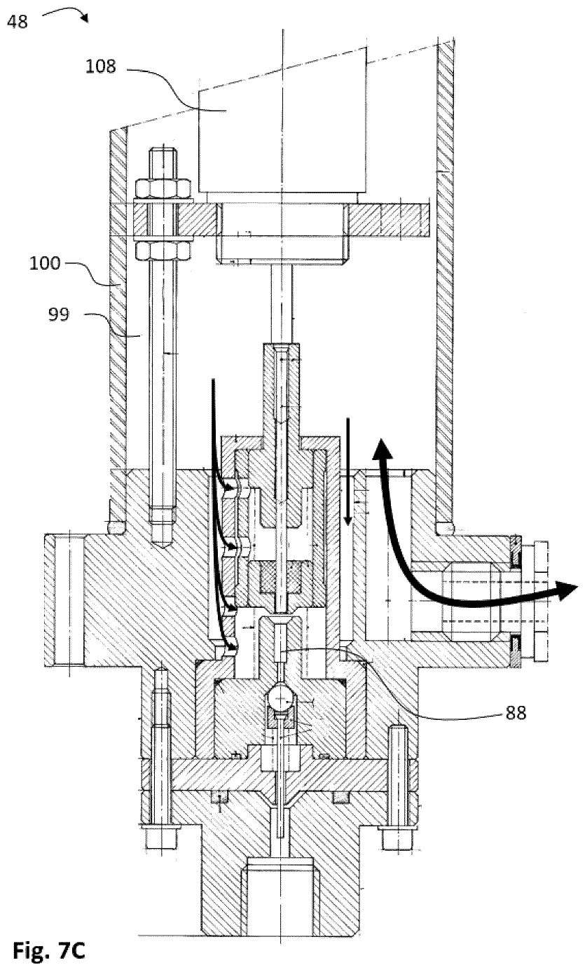

In the depicted system 2, the lubrication oil dispenser system 10 comprises a first pump system 48a and a second pump system 48b. These pump systems can be any of the pump systems described herein, for example the pump system that is shown in FIG. 5 and/or FIG. 6 and/or FIG. 7.

The system 2 further comprises an oil level meter 12 that is configured to measure an amount of oil in the dispenser system 10. Oil level meter 12 may function similarly as oil level meter 4. Oil level meter 12 may be understood as a safety measure. Bearings should not run dry. Therefore, the oil level in the dispenser system 10 is preferably always higher than some minimum level. At the same time, the oil level in the dispenser system 10 should not be too high, because this may cause oil to overflow and possibly spill into the system.

Preferably, the system 2 is hermetically sealed so that the absolute pressure in the system is lower than 5 mbar. Preferably, the system operates in full vacuum or near full vacuum.

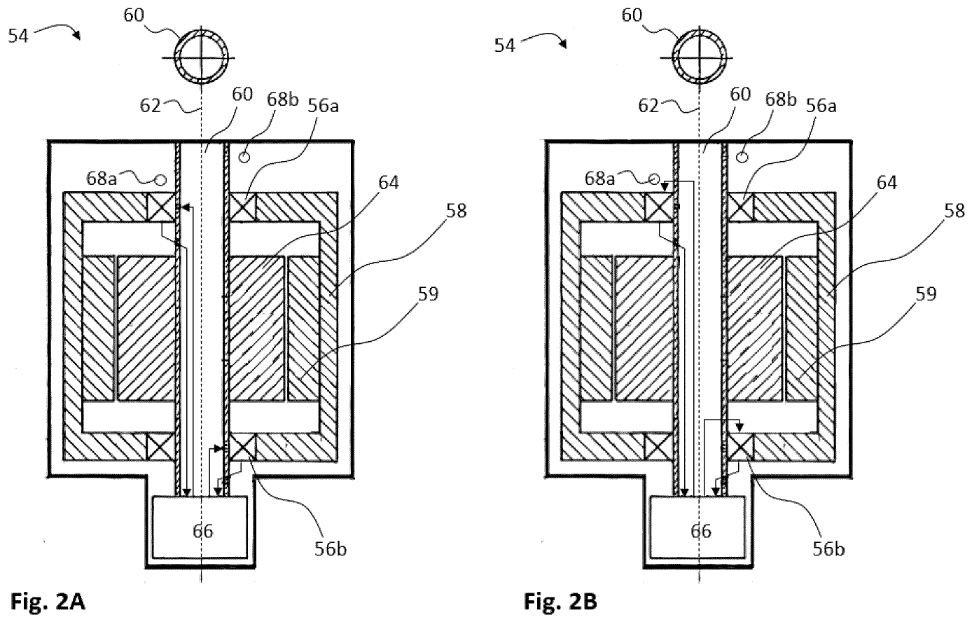

FIG. 2A schematically depicts a flywheel configuration 54 comprising bearings 56a and 56b that may be lubricated using a lubrication oil circulation system 2 as described herein, e.g. as depicted in FIG. 1. The bearings 56a and 56b rotatably connect the flywheel 58 to hollow shaft 60. Also see the cross section of the hollow tube at the top of FIG. 2. The flywheel 58 can thus rotate around axis 62. Attached to the inside of the flywheel is a rotor 59 that rotates with the flywheel 59 around the hollow shaft 60. A stator 64 is connected to the hollow shaft 60. The flywheel 54 further comprises a lubrication oil distribution system 66. The arrows to and from this distribution system 66 indicate the oil return lines resp. the oil supply lines that transport used (contaminated) lubrication oil from the bearings back to the distribution system and, respectively, that transport clean lubrication oil from the distribution system 66 to the bearings 56. A hybrid bearing may require a minimum amount of lubrication oil per hour of 2 to 100 mm³. A hybrid bearing that will be suitable for the systems described herein may require a minimum amount of between 6 and 20 mm³ per hour.

Bearing 56a may receive oil that is dispensed by pump system 48a shown in FIG. 1 and bearing 56b may receive oil that is dispensed by pump system 48b shown in FIG. 1.

The bearings may be rolling bearings. The rolling elements in these bearings may comprise, preferably consist of, ceramic. The bearings may thus be so-called hybrid bearings.

The stator and rotor are part of an electromotor-generator that may be connected to one or more photovoltaic cells, preferably one or more PV cells installed on a residential building. The electromotor-generator may be configured to drive the flywheel 58, when it is in a first state. The electromotor-generator would then be powered by the PV cells that are for example installed on a residential building, such as a house. In a second state, the electromotor-generator functions as a generator that is configured to convert the kinetic energy stored by the flywheel into electrical energy. The required electrical connections for the electromotor-generator are present inside of the hollow tube 60 (not shown). Preferably, the electromotor-generator comprises a dump load resistor that can quickly dissipate energy if the flywheel has to halt. This would for example be the case if the flywheel becomes unstable.

As a safety measure, the flywheel 54 may comprises one or more vibration sensors 68a and 68b. Heavy vibrations due to unbalance of the flywheel may be detected by the vibration sensors which can then control electrical circuitry to halt the flywheel. One of the vibration sensors is configured to primarily measure vibrations in a first direction. The other vibration sensor is configured to primarily measure vibrations in a second direction different from the first direction. Preferably, both the first and second direction lie on a plane that is perpendicular to axis 62. Additionally or alternatively, the first direction and second direction are perpendicular to each other.

FIG. 2B shows a flywheel configuration according to another embodiment. In this embodiment, the oil supply lines are configured to provide lubrication oil into the bearings from a side of the bearing that does not face the shaft 60 (as opposed to FIG. 2A).

As said, the oil circulation system and its components typically operate in (full) vacuum so that the flywheel experiences no air resistance. For control purposes, it will be desired that electrical conductors pass one or more flanges that function to maintain the vacuum inside of the oil circulation system.

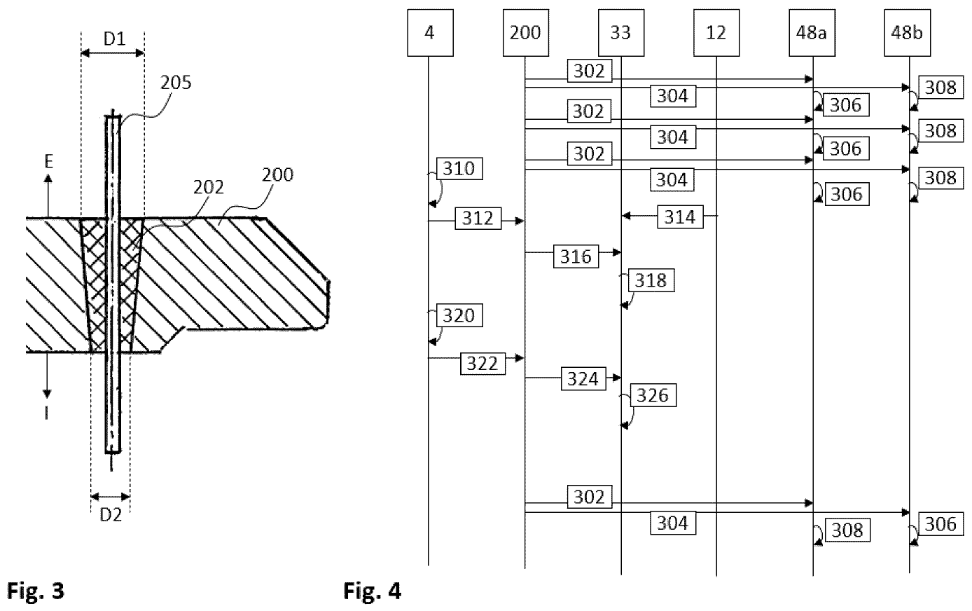

FIG. 3 illustrates a configuration, according to an embodiment, wherein an electrical conductor 205 passes through a flange 200. On one side E of the flange there is atmospheric pressure and on the other side of the flange I there is a vacuum. The electrical conductor 205 passes through a through-hole in the flange 200. The depicted through-hole has a conical shape. At the E-side, the through-hole has an opening with a diameter D1 and at the I-side the through-hole has an opening with a diameter D2 that is smaller than D1. A rubber seal 202 is provided in the through-hole. The rubber seal is attached to both the electrical conductor 205 and the flange 200 and isolates the conductor 205 from the flange 200. Due to the opening at the E-side being larger than the opening at the I side, and due to the pressure differential between the two sides of the flange, the seal 202 is pushed towards the I-side, which benefits the seal's sealing capabilities.

In one distinct aspect, this disclosure relates to a flange system. A number of embodiments of this flange system are disclosed in a concise manner by the following numbered clauses.
1. A flange system comprising a flange, and an electrical conductor, such as an electrical wire, and/or a tube, wherein the electrical conductor and/or tube passes through the flange from one side to another side through a through-hole in the flange, wherein the through hole has a first opening at said one side and a second opening at said other side, wherein the first opening is larger than the second opening, and wherein a seal is provided in the through-hole, the seal being attached to the electrical conductor and/or tube and to the flange and being configured to isolate the electrical conductor and/or tube from the flange.
2. The flange system according to clause 1, wherein there is a higher pressure on the one side than on the other side.
3. The flange system according to clause 1 or 2, wherein the through-hole has a conical shape.

In one distinct aspect, this disclosure relates to a method for fabricating a flange system. A number of embodiments of this method are disclosed in a concise manner by the following numbered clauses.
1. A method for fabricating a flange system comprising
providing a flange having a through-hole that has a first opening at one side of the flange and a second opening at another side of the flange, wherein the first opening is larger than the second opening, and
inserting an electrical conductor and/or tube through the through-hole, and
inserting a rubber material inside the through-hole, and
vulcanizing the rubber material so that the rubber material attaches to the electrical conductor and/or tube and to the flange.
2. The method according to clause 1, wherein the through-hole has a conical shape.

FIG. 4 is a flow chart illustrating a method according to an embodiment. A control system 200 periodically sends a control signal 302 to pump system 48a and a control signal 304 to pump system 48b. These signals respectively the pump systems 48a and 48b to perform a pump stroke, indicated by step 306, 308 respectively. In particular, the signal 302 and 304 may control a solenoid of each pump system.

At some point in time, the oil level meter 4 that is configured to measure an amount of oil in the holding space of the oil recovery system, measures in step 310 that some amount of oil is present in the holding space. At this point in time, for example, the floater 22 indicated in FIG. 1 may hit the top electrodes 26. In response, the oil level meter 4 sends signal 312 indicative of the measured amount of oil in the holding space, to control system 200. The control system 200, then, based on signal 312 causes the heating system 33 to perform a step 318 of heating the oil in the holding space so that some of the oil evaporates. The boiling process may continue for a predetermined period of time. In an embodiment, the heater system 33 shuts itself off if that predetermined period of time has passed.

However, in the embodiment of FIG. 4, the oil level meter 4 measures in step 320 again an amount of oil in the holding space. At this time, an amount of oil may have evaporated out of the container causing the floater 22 to contact the bottom electrodes 30 shown in FIG. 1. As a result, the oil level meter 4 sends signal 322 to the control system 200 indicative of the measured amount of oil in the holding space. Then, based on the signal 322, the control system sends a control signal 324 to the heater system herewith causing the heater system 322 to lower its heat production, preferably to switch off, so that the oil in the holding space no longer evaporates. Indeed, the heater system 33 switches off in step 326.

In the flow chart, the control system 200 is shown to start sending control signals to the pump systems 48a and 48b again after the boiling process has completed. However, it should be appreciated that these control signal can also be sent by the control system 200 during the boiling process.

FIG. 5 illustrates a pump system 48 according to an embodiment. The pump systems 48 is configured to dispense an amount of oil. The pump system comprises a static structure 70. Preferably, the static structure is part of, or may be fixed to, a housing 72 of the pump system. The pump system 48 is preferably substantially circularly symmetric around axis 71. Therefore, housing 72 is preferably shaped as a cylinder having a circular base. The pump system 48 also comprises a check-valve 75 that is configured to allow oil to pass through upon a pressure differential between two sides of the check-valve exceeding a threshold value. Further, a first piston 74 is movable relative to the static structure 70. Further, a second piston 76 is movable relative to the static structure 70 and movable relative to the first piston 74. A first spring 78 abuts at one end to the first piston 74 and abuts at another end to the second piston 76. A second spring 80 abuts at one end to the first piston 74 and at another end to the static structure 80. Preferably, these springs have substantially equal spring constants.

In the depicted embodiment, the housing 72 comprises one or more through-holes 84a, 84b, 84c, 84d so that oil can flow freely into the housing. Also the first piston 74 comprises one or more through holes 82a, 82b so that oil can flow freely into the interior of the first piston 74, where, in this case, spring 78 and at least part of the second piston 76 are present. In use, the depicted pump system 48 may be immersed in lubrication oil.

The pump system 48 also comprises a seal 86 which may comprise vulcanized rubber. The seal 86 lets the second piston 76 at least partially slide through the first piston 74 while at the same time maintaining a leak free connection between the two pistons. This prevents oil to leak out of area 88 once it has been closed off.

A typical height h4 is approximately 5 cm.

FIG. 6 schematically illustrates the pump system 48 in operation. In particular FIG. 6 depicts an initial configuration of the pump system right before the start of a pump stroke (left), an intermediate configuration of the pump system during a pump stroke (middle), and an end configuration of the pump system at the end of a pump stroke (right). Note that the static structure 70 and the housing 72 are depicted static during the pump stroke.

The pump system 48 may comprise a solenoid (not shown) that drives the second piston 76 from the position as shown on the left over a distance d1 +d2 to the position shown on the right. The position of the second piston 76 as depicted on the left may also be referred herein to as the third position and the position of the second piston 76 as depicted on the right may also be referred to herein as the fourth position. As will be explained in more detail below, this movement causes the first piston 74 to move over a distance d3 from a first position (left) to a second position (middle).

The first piston 74 is in the second position both when the pump system is in the intermediate configuration (middle) and when the pump system is in the end configuration (right). As can be seen, when the first piston 74 is in the second position, the first piston 74, second piston 76, static structure 70 and check-valve 75 close off area 88 that at that time contains to-be-dispensed oil. In the depicted embodiment, surface 90 of the static structure 70 (see FIG. 5) and surface 92 of the first piston 74 (also see FIG. 5) are complementary to each other so that these surfaces sit tight against each other when the first piston is in the second position. This ensures that no oil leaks out of closed off area 88 between the static structure 70 and the first piston 74. In the depicted embodiment surfaces 90 and 92 are conically shaped.

When the pump system is driven from the initial configuration (left) to the intermediate configuration (middle), the second piston is driven a distance d1 downwards. A typical value of d1 is 2 mm. This causes spring 78, which is already in a compressed state in the initial configuration (left), to push the second piston 74 downwards as well over a distance d3. A typical value of d3 is 1 mm. Due to the downward movement of the first piston 74, spring 80 is also (further) compressed in the intermediate configuration (middle). The second piston 76 moves over a greater distance relative to the static structure 70 than the first piston 74 (d1 is larger than d3). Hence, when the pump system is driven from the initial configuration (left) to the intermediate configuration (middle), the second piston 76 moves relative to the first piston 74. This relative movement is indicated by d4. As a side note, d1=d3+d4. The position of second piston 76 relative to the first piston 74 as shown in the intermediate configuration (middle) is referred to herein as the initial position of the second piston 76 relative to the first piston 74.

In the intermediate configuration (middle), the static structure 70 blocks the first piston 74 from moving further downwards. However, when the pump system, in particular the second piston 76, is driven further, the pump system transitions from the intermediate configuration (middle) to the end configuration (right). The second piston 76 then moves relative to the first piston 74, over a distance d5−d4, into the closed-off area 88. As a side note, since the first piston 74 does not move when the pump system transitions from the intermediate configuration to the end configuration, d5−d4=d2. As a result of the second piston 76 entering the area 88, the pressure in the closed-off area 88 is increased, which causes the check-valve 75 to allow oil to pass from the area 88 through the check-valve 75 for being dispensed out of the pump system. The amount of oil that is dispensed out of the pump system depends on the how large the volume is of the part that moves into the closed-off area 88. In an example, the part of the piston that moves into the area 88 has a diameter of 1.5 mm and moves 3.9 mm into the area. Hence, the amount of oil dispensed per stroke would be approximately 6.9 mm³. If the pump system is for example used to oil a bearing requiring 20 mm³ oil per hour, then the pump system will need to perform 3 pump strokes per hour. Of course, the dimensions of the pump parts and the periodicity of the pump strokes can be varied as desired.

The position of the second piston 76 relative to the first piston as depicted in the end configuration (right) is referred to herein as the end position relative to the first piston. In the depicted embodiment, in the end configuration (right), the second piston 76 is thus in the end position relative to the first piston 74 and, at the same time, in the fourth position relative to the static structure 70. In this end position, a surface 91 (indicated in the middle figure) of the second piston abuts a surface 93 (indicated in the middle figure) of the first piston. As such, the first piston 74 stops the second piston 76 from moving further.

At the end of the pump stroke, when driving force F is no longer applied to the second piston 76, the springs 78 and 80 push the first piston 74 and the second piston 76 back to their respective positions as shown in the initial configuration (left). Upon the first piston 74 moving back to its first position, the area 88 is opened up so that new to-be-dispensed oil can flow from outside the area 88 into the area 88.

FIG. 7A illustrates (top view and a cross section) an embodiment of a pump system 48 that comprises an oil-containing oil reservoir 99. In this embodiment, the first spring and/or the second spring are positioned in the oil reservoir 99 and are immersed in the oil in the oil reservoir 99.

The oil reservoir may be at least partially formed by a glass cylinder tube 100 covered by a lid 102. In order to prevent leakage, a seal, such as an O-ring 104, may be positioned between the lid 102 and the cylinder tube 100. The glass tube 100 may be clamped between the lid 102 and pump housing 72, for example by means of a threaded rod that engages with nuts on either side of the lid 102 and, respectively, the pump housing 72.

In the depicted embodiment, a solenoid 108 is present in the oil reservoir 99 and the solenoid 108 is immersed in the oil. The solenoid is closed off by a flange 110 and a nut 112. The solenoid is configured to drive down a piston 115 that is connected to the second piston 76 described herein. To this end, the solenoid is comprises electrodes 103 for connecting the solenoid to an electrical power source.

Various parts of the pump system, such as the first spring 78, the second spring 80, first piston 74, second piston 76, static structure 70, check-valve 75 are present inside the housing 72.

The oil reservoir comprises an inlet 118 that allows to oil to flow into the oil reservoir.

The oil reservoir comprises an inlet 118 that allows to oil to flow into the oil reservoir. The oil flowing into the oil reservoir is preferably clean oil that has been obtained by an oil recovery system described herein.

In order to fix the solenoid 108 inside the oil reservoir 99, it may be fixed, for example by means of threaded rods 114 and nuts, to housing 72.

The oil reservoir comprises a lid 120 at its bottom end that may be secured by means of nuts and bolts 122. Element 124 indicates a flange connector to which suitable tubing can be connected for transporting the pumped oil to for example a bearing.

FIG. 7B shows the oil level meter 12 configured to measure an amount of oil in the pump system 48. As shown, the pump system 48 and the oil level meter 12 are fluidly connected so that they are communicating vessels and so that the oil surface in the pump system will be at the same height as the oil surface in the oil level meter 12. A typical height h3 is for example between 10 and 20 cm, such as approximately 15 cm.

FIG. 7C shows the pump system of FIGS. 7A and 7B in more detail. The arrows indicate how oil from the oil reservoir 99 can enter into the pump housing via the through holes 82 and 84 (see FIG. 5) so that the oil can reach area 88.

The thick arrow indicates that the oil reservoir 99 is in fluid communication with the oil level meter 12.

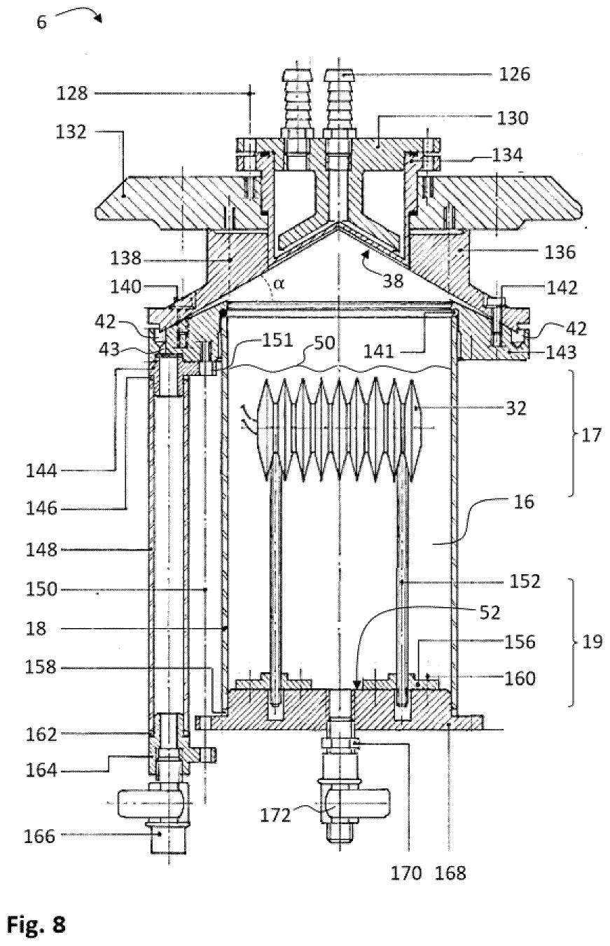

FIG. 8 illustrates an oil recovery system 6 according to an embodiment for recovering oil. Container 18 defines a holding space 16 for holding oil. Again, the holding space 16 comprises an upper region 17 and comprises a lower region 19 for receiving solid contaminants that have sunk through the oil in the holding space 16. The oil recovery system also comprises a heating system that is configured to heat oil in the upper region 17 to a greater extent than oil in the lower region 19. In the depicted embodiment, heater element 32 is positioned closer to the oil surface 50 than to the bottom surface 52 of container 18 and closer to condensation surface 18 than to the bottom surface 52. The heating system is configured to cause oil in the upper region 17 to evaporate. The oil recovery system further comprises a condenser system that is configured to condense the evaporated oil and guide the condensed oil out of the container 18.

FIG. 8 further shows hose pillars 126 for connecting tubing through which cooling fluid can enter into and out of the cooling system 134. These hose pillars 126 are screwed into flange 130. Flange 130 may be secured together with cooling system 134 to flange 132 by means of hex bolts 128. Flange 132 in turn is secured to a lid 136 by means of hex bolts 138. Lid 136 comprises a conically shaped inner surface 38 as condensation surface. Oil vapor condenses on the inner surface 38 after which the thus formed oil droplets on surface 38 will hang on surface 38 and will slide towards drain channel 42 that is present in a collar structure 143 around the opening of the container 18. The angle of inclination a should not be too small to prevent that condensed oil droplets fall back into the container. On the other, if the angle of inclination is relatively large, then the condensation surface 38 will be relatively far removed from the oil surface meaning that the oil vapor has to travel over a relatively large distance before it reaches the condensation surface 38. This may be disadvantageous, especially if a lubrication oil is used having a relatively low vapor pressure, such as PAO2, because the oil may already condense and fall back into the holding space before it reaches the condensation surface 38. Hence, a lower angle of inclination in principle benefits the yield of the boiling process, at least in terms of how many oil droplets are formed on the condensation surface. Thus, the chosen angle of inclination a is a trade-off. An appropriate value for a is for example 30 degrees. The lid 136 may be secured to the collar structure 143 by means of hex bolts 140, 142. An O-ring 141 is placed between the container 18 and the collar structure 143 in order to prevent leakage.

The oil that has ended up in drain channel 42 will flow to a drain 43 via which the clean, condensed oil can enter into a glass tube 148. A tube holder 144 is placed between the drain 43 and the glass tube 148. O-ring 146 is positioned between the tube holder 144 and the glass tube 148 in order to prevent leakage.

Threaded rod 150, and appropriate nuts, e.g. nut 151, is used to clamp the container 18 between the collar structure 143 and bottom flange 168. An O-ring 158 is provided between a side wall of the container 18 and the bottom flange in order to prevent oil leakage.

Glass tube 148 is positioned on a tube holder 164 at its bottom and an O-ring 162 is provided between the glass tube 148 and tube holder 164. A faucet 166 is present below the tube 148 the faucet being configured to control the oil flow out of the glass tube 148.

Heater element 32 is place on threaded rods 152.

Further a nipple 170 is used to connect a faucet 172 to the holding space 16. Faucet 172 can be used to let oil out of the holding space. This is for example convenient when the oil in the oil circulation system has to be replaced.

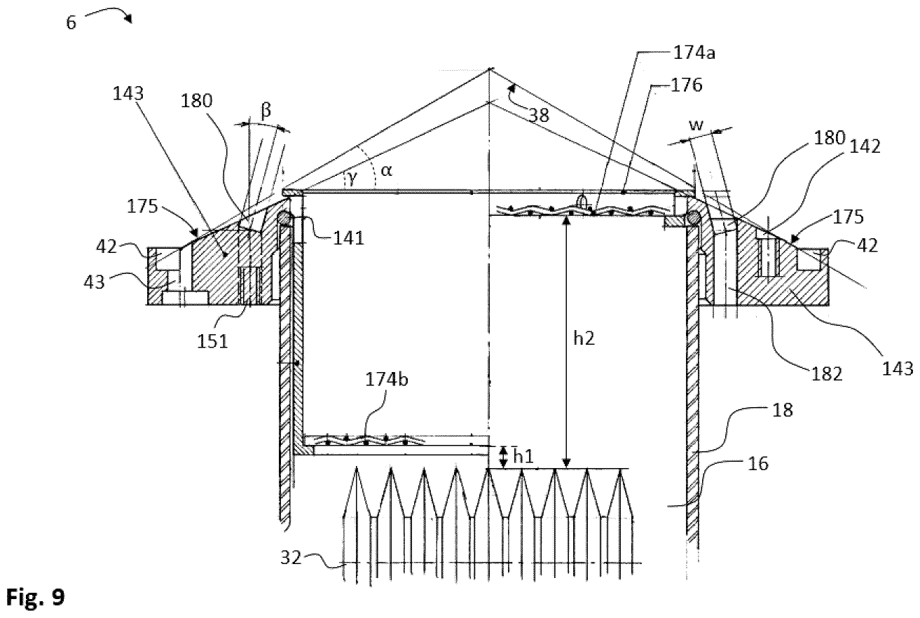

FIG. 9 illustrates an oil recovery system 6 according to an embodiment. In this embodiment, the oil recovery system 6 comprises a mesh structure 174 in the holding space 16. This mesh structure 174 is configured to burst bubbles that are rising the oil in the holding space 16 when at least some of the oil is boiling. FIG. 9 shows that the mesh structure may be placed at various heights relative to heater element 32 and/or relative to the container 18. FIG. 9 shows two options combined in one figure. However, it should be appreciated that preferably a single mesh structure 174 is present in the holding space, that is positioned at a certain height. On the left hand side, the mesh structure 174b is depicted at a height h1 above the heater element 32, whereas on the right hand side the mesh structure 174a is positioned at a height h2. A basket structure 176 is present for supporting the mesh structure 174.

The oil recovery system of FIG. 9 also comprises a collar 143 around the container 18. In FIG. 9, a top surface 175 of the collar has a conical shape. The collar comprises a second annular recess 42 in the top surface 175 that functions as the drain channel 42 referred to above. The collar further comprises, closer to the container 18, another, first annular recess 180 in the top surface 175. The, optionally conical, top surface 175 of the collar 143 preferably has an angle of inclination γ that is smaller than the angle of inclination α of the condensation surface 38. γ for example has a value of approximately 20 degrees, whereas α may have a value of approximately 30 degrees. Condensed oil droplets hanging from condensation surface will in principle slide towards and fall into the drain channel 42. Herewith, these droplets pass over the first annular recess 180.

However, contaminated oil that is expelled out of the container unintentionally, for example due to the splashing of the boiling oil at the oil surface, will, at least to some extent, end up in first annular recess 180. Annular recess 180 is preferably sloped towards a drain 182 via which the contaminated oil can leave the recess 180.

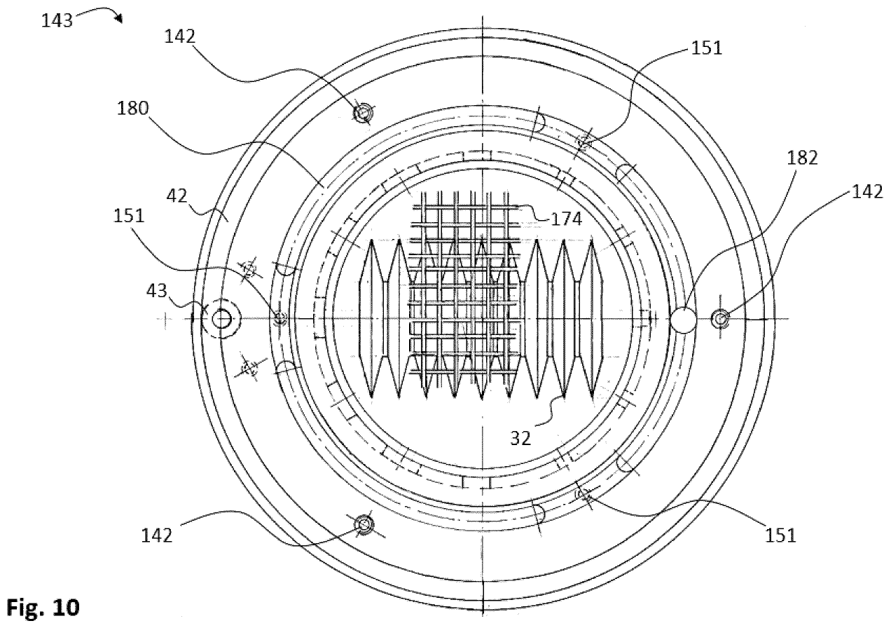

It should be appreciated that any of the annular recesses referred to herein are not necessarily perfectly circular. However, in the embodiment of FIG. 10, which shows a top view of collar 143 depicted in FIG. 9, both the first recess 180 and the second recess 42, also referred to as the drain channel 42, are circular and both completely surround the container 18.

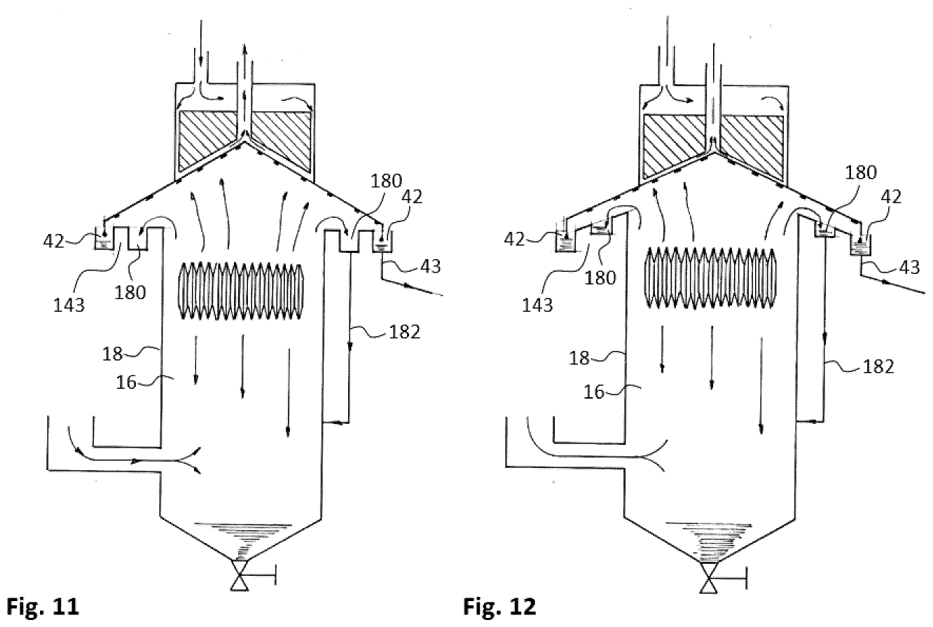

FIGS. 11 and 12 show respective embodiments of the oil recovery system each comprising a collar 143 positioned around the container 18, wherein the collar 143 comprises a first recess 180 and a second recess 42 that is more distant from the container 18 than the first recess 143, wherein the condenser system is configured to guide the condensed oil into the second recess 42.

FIG. 11, shows the that the collar 143 extends substantially horizontally. FIG. 11 also shows that contaminated oil that has ended up in the first recess 180 flows back via drain 182 into the holding space defined by the container 18, preferably into a lower region of the holding space.

FIG. 12 shows an embodiment of the oil recovery system wherein the collar 143 is conically shaped, in particular shaped such that a tip of the (virtual) cone points upwards. This embodiment decreases the distance that the evaporated oil has to travel before it reaches the condensation surface.

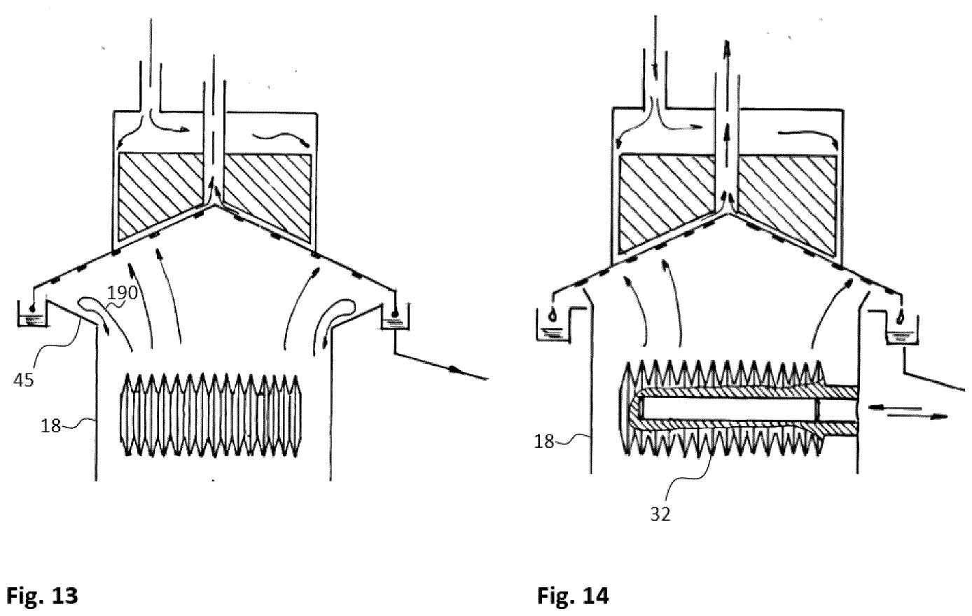

FIG. 13 illustrates an embodiment wherein the container 18 comprises an edge 45 that is tilted outwardly. As shown, oil 190 that is launched may land on the edge 45 after which it will flow back into the container. Preferably, the oil surface never reaches the edge 45.

FIG. 14 shows an embodiment of the oil recovery system comprising a heater element 32 that can be easily replaced. The heater element can be inserted through a through-hole in the container 18. Of course, a suitable seal is provided in order to prevent leakage.

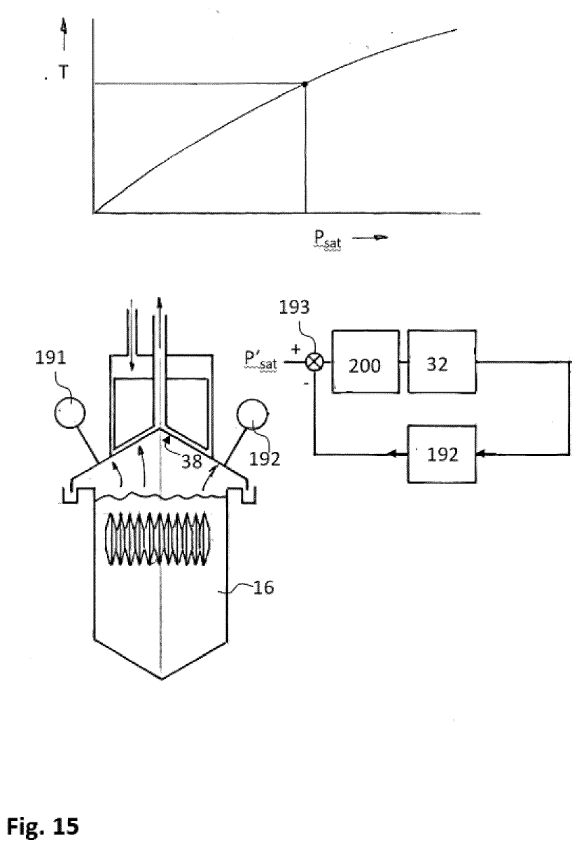

FIG. 15 schematically illustrates an embodiment of the oil recovery system wherein the heater system is controlled based on a vapor pressure as measured in the holding space.

The saturation vapor pressure of a substance is the pressure at which a vapor of that substance is in thermodynamic equilibrium with its condensed state. At pressures higher than vapor pressure, the substance would condense, whilst at lower pressures it would evaporate or sublimate. The saturation vapor pressure increases with increasing temperature and can be determined with the Clausius-Clapeyron relation. At the top, FIG. 15 illustrates a typical dependence between the saturated vapor pressure (horizontal axis) and temperature (vertical axis).

In this embodiment, the oil recovery system comprises a temperature sensor 191 that is configured to measure a temperature of the oil vapor and a pressure sensor 192 that is configured to measure the oil vapor pressure in the holding space.

The boiling process begins by the heater system heating the oil in the holding space until a predetermined oil vapor pressure and a predetermined temperature is reached. These predetermined values are determined such that they lie on the curve depicted at the top. Oil in the holding space will be evaporating at these values. However, due to oil vapor condensing on the, preferably actively cooled, condensation surface 38, the oil vapor pressure will decrease.

In this embodiment, the heater system is controlled based on the oil vapor pressure in the following manner. The oil vapour pressure is repeatedly, preferably continuously, measured by the pressure sensor 192. Subsequently, the measured pressure is compared (indicated by 193) with the predetermined value P′ₛₐₜ. If the measured pressure is higher than the predetermined value, a control system 200 causes heater system 32 to lower its heat production, e.g. causes heater system 32 to switch off. If the measured pressure is lower than the predetermined value, control system 200 causes heater system 32 to increase its heat production, e.g. causes heater system 32 to switch on. This control mechanism enables to keep the vapor pressure constant at the saturated vapor pressure. Herewith it is ensured that the oil does not become warmer than necessary, which reduces energy waste. A further advantage of this control mechanism is that it reduces the risk of thermal cracking of the oil.

The temperature sensor 191 may be regarded as a safety measure that allows to monitor the boiling process. Too high temperatures can be prevented in this manner. It should be appreciated, however, that the control of the heater system 32 may be based on the pressure only, i.e. not necessarily on a measured temperature.

One aspect of this disclosure relates to a computer-implemented method for controlling a heating system of an oil recovery system as described herein, wherein the oil recovery system comprises a pressure sensor that is configured to measure an oil vapor pressure in the holding space. In this aspect, the method comprises receiving from the pressure sensor a signal indicative of a current oil vapor pressure in the holding space, and causing, based on the measured pressure, the heating system to heat the oil in the holding space herewith causing at least some of the oil in the holding space to evaporate.

In an embodiment, this method comprises causing, based on the measured pressure, the heating system to increase or decrease its heat production.

In an embodiment, this method comprises comparing the measured pressure with a predetermined value, and causing the heating system to increase or decrease its heat production.

In an embodiment, comparing the measured pressure with a predetermined value comprises determining that the measured pressure is higher or lower than the predetermined value, and then the method comprises, based on this determination, causing the heating system to decrease or, respectively, increase its heat production.

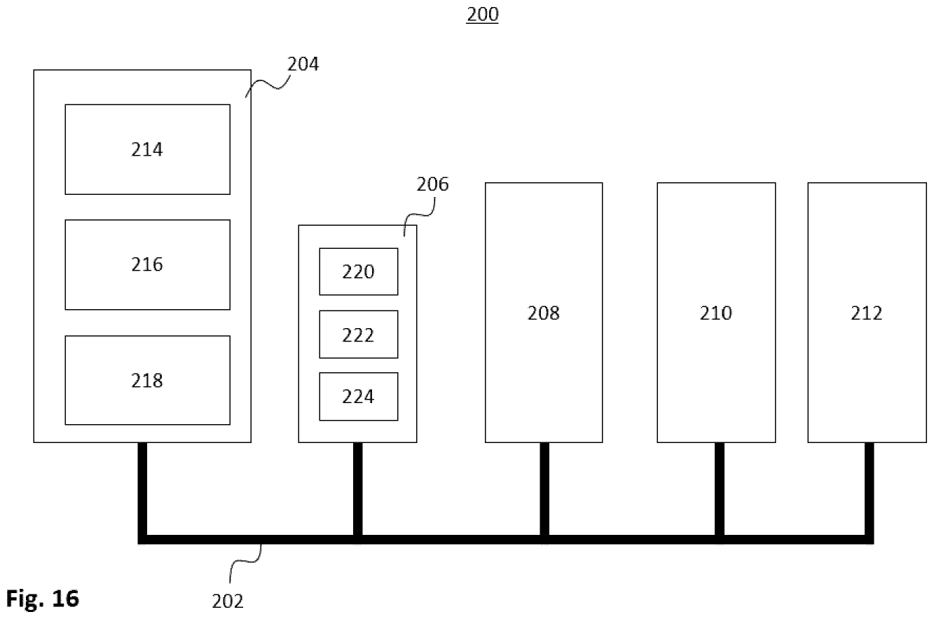

FIG. 16 schematically illustrates a data processing 200, also referred to as a computer, according to an embodiment. The data processing system 200 may for example represent a control system as described herein.

In data processing system 200, a system bus 202 connects the different components of the data processing system 200. In particular, the system bus 202 depicted in FIG. 16 connects the Central Processing Unit (CPU) 204, memory elements 206, input devices 208, output devices 210 and communication devices 212 with each other so that they can exchange information. The system bus 202 may be understood to serve both as data bus, address bus and control bus known in the art.

The CPU 204 is configured to perform steps as per the instructions comprised in a computer program. To illustrate, based on such instructions, the CPU may perform any of the computer-implemented methods described herein. Typically, the CPU 204 is embodied as a microprocessor, which can be implemented on a single metal-oxide-semiconductor integrated circuit chip. The CPU 204 comprises a control unit 214, an arithmetic logical unit (ALU) 216 and a plurality of registers 218. The control unit 214 is configured to retrieve instructions from a main memory 120. Typically, the control unit 214 comprises a binary decoder to convert the retrieved instructions into timing and control signals that direct the operation of for example the ALU 216. ALU 216 is configured to perform logical operations, such as additions, subtraction, multiplication, division and Boolean operations, that are required for carrying out the instructions. The registers 218 are small memory elements that can be read and written at relatively high speed. A register may for example store an instruction, a storage address, or any other kind of data. In addition, the CPU may contain hardware caches known in the art (not shown). Preferably the CPU has different levels of caches. These hardware caches may be understood as an intermediate state between the faster registers 219 and the slower main memory 120.

Memory elements 206 comprise a main memory 120. The main memory 120, also referred to as primary storage in the art, has stored data that is directly accessible to the CPU 204. The CPU 204 may continuously read instructions, i.e. read computer programs, stored in the main memory 120 and execute these instructions. The main memory 120 is typically a random access memory (RAM).

Memory elements 206 further comprise so-called secondary storage 122, which may be embodied as one or more hard disk drives and/or as one or more solid state drives. Typically, these secondary storage is non-volatile. Further, the memory elements may comprise other storage devices 124, such as removable storage devices, e.g. CD, DVD, USB flash drives, floppy disks, et cetera.

Input devices 208 may be understood as devices that are used to provide information to the computer 200, in particular to the CPU 204. Non-limiting examples of input devices are a keyboard, a microphone, a joystick, a mouse, a touch sensitive screen, et cetera. Output devices 210 may be understood as devices that output information out of the computer and/or as devices that are controlled by the computer. Non-limiting examples of output devices 210 are a display, a printer, a headphones, loudspeaker, a motor-generator referred to herein, any of the actuators referred to herein, et cetera.

Communication devices 212 may be understood as devices that allow the computer system to communicate with other computers, such as with a server computer, client computer, or any other type of remote device. Non-limiting examples of communication devices 212 include modems, cable modems, ethernet cards, Bluetooth modules, et cetera.

The following numbered clauses define a number of embodiments in a concise manner.
1. A hermetically sealed lubrication oil circulation system comprising
a lubrication oil dispenser system that is configured to provide lubrication oil to a bearing, and
a container defining a holding space for holding contaminated lubrication oil that has come out of the bearing, and
an oil recovery system that is configured to boil the contaminated lubrication oil in order to evaporate clean lubrication oil and condense the clean, evaporated lubrication oil, and
a transport system that is configured to transport the clean, condensed lubrication oil to the lubrication oil dispenser system so that the lubrication oil dispenser system can provide the clean lubrication oil to the bearing.
2. The lubrication oil circulation system according to clause 1, further comprising an oil level meter that is configured to measure an amount of contaminated lubrication oil in the holding space.
3. The lubrication oil circulation system according to clause 1 or 2, wherein the oil circulation system is configured to accommodate a pressure that is lower than 5 mbar absolute.
4. A hermetically sealed system comprising the lubrication oil circulation system according to any of the preceding clauses and the bearing.
5. The system according to clause 4, wherein the bearing is a rolling bearing.
6. The system according to clause 5, wherein the rolling bearing comprises rolling elements comprising ceramic.
7. The system according to any of the preceding clause 4-6, further comprising a flywheel comprising the bearing, the flywheel being configured to store kinetic energy, and an electromotor that is configured to power the flywheel.
8. The system according to clause 7, further comprising a generator that is configured to convert the kinetic energy stored by the flywheel into electrical energy.
9. The system according to clause 7 or 8, further comprising a photovoltaic cell that is configured to power the electromotor.
10. The system according to any of the preceding clauses, wherein the lubrication oil dispenser system comprises a pump system according to any of the clauses 12-24.
11. The system according to any of the preceding clauses, wherein the oil recovery system is the oil recovery system as defined in any of clauses 25-34.
12. A pump system that is configured to dispense an amount of oil, the pump system comprising
a static structure, and
a check-valve, wherein the check-valve is configured to allow oil to pass through upon a pressure differential between two sides of the check-valve exceeding a threshold value, and
a first piston that is movable relative to the static structure between a first position and a second position, and
a second piston that is movable relative to the static structure and movable relative to the first piston, wherein
the first piston, second piston, static structure and check-valve are configured to, when the first piston is in the second position, close off an area containing to-be-dispensed oil, and wherein
the second piston is configured to move relative to the first piston into the closed-off area for increasing a pressure in the closed-off area for causing the check-valve to allow oil to pass from the area through the check-valve for being dispensed out of the pump system, wherein the pump system further comprises
a first spring abutting at one end of the first spring to the first piston and abutting at another end of the first spring to the second piston, and
a second spring abutting at one end of the second spring to the first piston and at another end of the second spring to the static structure.
13. The pump system according to clause 12, wherein the first piston and second piston are configured to, upon the first piston moving back to the first position, open up the area so that new to-be-dispensed oil can flow from outside the area into the area.
14. The pump system according to clause 12 or 13, wherein
at least part of the second piston is movable through the first piston, and wherein
the pump system comprises a seal between the first piston and the second piston.
15. The pump system according to clause 14, wherein the seal comprises vulcanized rubber.
16. The pump system according to any of the preceding clauses 12-15, wherein
the second piston is configured to move relative to the first piston into the closed-off area for increasing the pressure hereby moving from an initial position relative to the first piston to an end position relative to the first piston and hereby moving to a fourth position relative to the static structure, and wherein
the first spring is configured to cause the second piston to move back from the end position to the initial position.
17. The pump system according to any of the preceding clauses 12-16, wherein
the second piston is movable relative to the static structure between a third position and a or the fourth position, wherein
the first spring is configured to, when the second piston is moving from the third position to the fourth position, cause the first piston to move from the first position to the second position.
18. The pump system according to clause 16 or 17, wherein
the first spring is configured to be in a compressed state when the second piston is in the end position relative to the first piston.
19. The pump system according to any of the preceding clauses 12-18, wherein the second spring is configured to cause the first piston to move back from the second position to the first position.
20. The pump system according to clause 19, wherein the second spring is configured to be in a compressed state when the first piston is in the second position.
21. The pump system according to any of the preceding clauses 12-20, wherein the first spring and the second spring have substantially equal spring constants.
22. The pump system according to any of the preceding clauses 12-21, further comprising a solenoid that is configured to drive the second piston from a or the third position to a or the fourth position.
23. The pump system according to any of the preceding clauses 12-22, further comprising an oil-containing oil reservoir, wherein
the first spring and/or the second spring are positioned in the oil reservoir and are immersed in the oil in the oil reservoir.
24. The pump system according to any of the preceding clauses, wherein the pump system is configured to dispense, with each pump stroke, an amount of oil less than 30 cubic millimeter, preferably less than 20 cubic millimeter, more preferably less than 10 cubic millimeter.
25. An oil recovery system for recovering oil, the oil recovery system comprising
a container defining a holding space for holding oil, wherein the holding space comprises an upper region and comprises a lower region for receiving solid contaminants that have sunk through the oil in the holding space, and
a heating system that is configured to heat oil in the upper region to a greater extent than oil in the lower region, wherein the heating system is configured to cause oil in the upper region to evaporate, and
a condenser system that is configured to condense the evaporated oil and guide the condensed oil out of the container.
26. The oil recovery system according to clause 25, wherein the heating system is configured to cause oil in the upper region to boil without causing oil in the lower region to boil.
27. The oil recovery system according to clause 25 or 26, wherein
the heating system comprises a heater element that is configured to convert electrical energy into heat, wherein
the heater element sits in the holding space.
28. The oil recovery system according to any of the preceding clauses 25-27, wherein
the heating system comprises a or the heater element that is configured to convert electrical energy into heat, wherein
the heater element is positioned nearer to the upper region than to the lower region of the holding space.
29. The oil recovery system according to clause 27 and 28, wherein the heater element is positioned in the upper region of the holding space.
30. The oil recovery system according to any of the preceding clauses 25-29, wherein
the heating system comprises a or the heater element that is configured to convert electrical energy into heat, and wherein
the condenser system comprises a condensation surface that is configured to cause the evaporated oil to condense on it, wherein
the heater element is positioned closer to the condensation surface than to the lower region of the holding space.
31. The oil recovery system according to any of the preceding clauses 25-30, wherein
the holding space is holding an amount of oil as a result of which an oil surface is present in the holding space, wherein
the heater element is positioned closer to the oil surface than to the lower region of the holding space.
32. The oil recovery system according to any of the preceding clauses 25-31, further comprising a mesh structure in the holding space that is configured to burst bubbles that are rising in the oil in the holding space.
33. The oil recovery system according to any of the preceding clauses 25-32, further comprising
a collar provided at least partially around the container, wherein the collar comprises a first recess and a second recess that is more distant from the container than the first recess, wherein
the condenser system is configured to guide the condensed oil into the second recess.
34. The oil recovery system according to any of the preceding clauses 25-33, further comprising an oil level measurement system that is configured to measure an amount of oil in the holding space.
35. The oil recovery system according to clause 34, further comprising a control system that is configured to perform steps of
receiving from the oil level measurement system a signal indicative of an amount of oil in the holding space, and
based on the indicated amount of oil in the holding space, causing the heating system to heat the oil in the holding space herewith causing at least some of the oil in the holding space to evaporate.
36. The oil recovery system according to clause 34 or 35, further comprising a or the control system that is configured to perform steps of
receiving from the oil level measurement system a second signal indicative of a second amount of oil in the holding space, and
based on the indicated second amount of oil in the holding space, causing the heating system to lower its heat production, preferably to switch off, so that the oil in the holding space no longer evaporates.
37. A computer-implemented method for controlling the heating system of the oil recovery system as defined in any of clauses 25-36, the method comprising
receiving from an or the oil level measurement system a signal indicative of an amount of oil in the holding space, and
based on the indicated amount of oil in the holding space, causing the heating system to heat the oil in the holding space herewith causing at least some of the oil in the holding space to evaporate.
38. The computer-implemented method according to clause 37, the method comprising
receiving from the oil level measurement system a second signal indicative of a second amount of oil in the holding space, and
based on the indicated second amount of oil in the holding space, causing the heating system to lower its heat production, preferably to switch off, so that the oil in the holding space no longer evaporates.
39. A computer program comprising instructions which, when the program is executed by a data processing system, cause the data processing system to perform the method according to clause 37 or 38.
40. A computer-readable storage medium having stored thereon the computer program of clause 39.

What is claimed is:

1. An oil recovery system for recovering oil, the oil recovery system comprising:
a container defining a holding space for holding oil, wherein the holding space comprises an upper region and comprises a lower region for receiving solid contaminants that have sunk through the oil in the holding space;
a heating system that is configured to heat oil in the upper region to a greater extent than oil in the lower region, wherein the heating system is configured to cause oil in the upper region to evaporate; and
a condenser system that is configured to condense the evaporated oil and guide the condensed oil out of the container.

2. The oil recovery system of according to claim 1, wherein the heating system is configured to cause oil in the upper region to boil without causing oil in the lower region to boil.

3. The oil recovery system of claim 1, wherein the heating system comprises a heater element that is configured to convert electrical energy into heat, wherein the heater element sits in the holding space.

4. The oil recovery system of claim 1, wherein the heating system comprises a or the heater element that is configured to convert electrical energy into heat, wherein the heater element is positioned nearer to the upper region than to the lower region of the holding space.

5. The oil recovery system of claim 3, wherein the heater element is positioned in the upper region of the holding space.

6. The oil recovery system of claim 1, wherein the heating system comprises a heater element that is configured to convert electrical energy into heat, and wherein the condenser system comprises a condensation surface that is configured to cause the evaporated oil to condense on it, wherein the heater element is positioned closer to the condensation surface than to the lower region of the holding space.

7. The oil recovery system of claim 1, wherein the holding space is holding an amount of oil as a result of which an oil surface is present in the holding space, wherein the heater element is positioned closer to the oil surface than to the lower region of the holding space.

8. The oil recovery system of claim 1, further comprising a mesh structure in the holding space that is configured to burst bubbles that are rising in the oil in the holding space.

9. The oil recovery system of claim 1, further comprising a collar provided at least partially around the container, wherein the collar comprises a first recess and a second recess that is more distant from the container than the first recess, wherein the condenser system is configured to guide the condensed oil into the second recess.

10. The oil recovery system of claim 1, further comprising an oil level measurement system that is configured to measure an amount of oil in the holding space.

11. The oil recovery system of to claim 10, further comprising a control system that is configured to perform steps of:
receiving from the oil level measurement system a signal indicative of an amount of oil in the holding space; and
based on the indicated amount of oil in the holding space, causing the heating system to heat the oil in the holding space herewith causing at least some of the oil in the holding space to evaporate.

12. The oil recovery system of claim 10, further comprising a or the control system that is configured to perform steps of
receiving from the oil level measurement system a second signal indicative of a second amount of oil in the holding space, and
based on the indicated second amount of oil in the holding space, causing the heating system to lower its heat production, preferably to switch off, so that the oil in the holding space no longer evaporates.

13. A hermetically sealed lubrication oil circulation system comprising:
a lubrication oil dispenser system that is configured to provide lubrication oil to a bearing;
a container defining a holding space for holding contaminated lubrication oil that has come out of the bearing;
an oil recovery system comprising:
a container defining a holding space for holding oil, wherein the holding space comprises an upper region and comprises a lower region for receiving solid contaminants that have sunk through the oil in the holding space.
a heating system that is configured to heat oil in the upper region to a greater extent than oil in the lower region, wherein the heating system is configured to cause oil in the upper region to evaporate, and
a condenser system that is configured to condense the evaporated oil and guide the condensed oil out of the container,
wherein the oil recovery system is configured to boil the contaminated lubrication oil in order to evaporate clean lubrication oil and condense the clean, evaporated lubrication oil; and
a transport system that is configured to transport the clean, condensed lubrication oil to the lubrication oil dispenser system so that the lubrication oil dispenser system can provide the clean lubrication oil to the bearing.

14. The lubrication oil circulation system of claim 13, wherein the oil circulation system is configured to accommodate a pressure that is lower than 5 mbar absolute.

15. The lubrication oil circulation system of claim 13, wherein the lubrication oil circulation system comprises a portion of a hermetically sealed system. the hermetically sealed system further comprising the bearing.

16. The system of claim 15, wherein the bearing is a rolling bearing.

17. (canceled)

18. (canceled)

19. (canceled)

20. (canceled)

21. A computer-implemented method for controlling a heating system of an oil recovery system, the oil recovery system comprising:
a container defining a holding space for holding oil, wherein the holding space comprises an upper region and comprises a lower region for receiving solid contaminants that have sunk through the oil in the holding space.
the heating system that is configured to heat oil in the upper region to a greater extent than oil in the lower region, wherein the heating system is configured to cause oil in the upper region to evaporate, and
a condenser system that is configured to condense the evaporated oil and guide the condensed oil out of the container, the method comprising:
receiving from an or the oil level measurement system a signal indicative of an amount of oil in the holding space; and
based on the indicated amount of oil in the holding space, causing the heating system to heat the oil in the holding space herewith causing at least some of the oil in the holding space to evaporate.

22. The computer-implemented method of according to claim 21, the method comprising:
receiving from the oil level measurement system a second signal indicative of a second amount of oil in the holding space, and
based on the indicated second amount of oil in the holding space, causing the heating system to lower its heat production, preferably to switch off, so that the oil in the holding space no longer evaporates.

23. The method of claim 21, wherein the method is performed by a computer program comprising instructions which, when the program is executed by a data processing system, cause the data processing system to perform the method.

24. The method of claim 23, wherein the computer program is stored on a computer-readable storage.
